(19) United States
(12) Patent Application Publication
(10) Pub. No.: US 2020/0134659 A1
(43) Pub. Date: Apr. 30, 2020

(54) SYSTEM AND METHOD FOR PROVIDING DISCOUNTS

(71) Applicants: Matthew T. Dennehy, Remsenburg, NY (US); Stephen E. Feldman, New York, NY (US)

(72) Inventors: Matthew T. Dennehy, Remsenburg, NY (US); Stephen E. Feldman, New York, NY (US)

(21) Appl. No.: 16/729,174

(22) Filed: Dec. 27, 2019

Related U.S. Application Data
(63) Continuation-in-part of application No. 14/643,739, filed on Mar. 10, 2015, now abandoned.
(60) Provisional application No. 62/024,746, filed on Jul. 15, 2014.
(60) Provisional application No. 61/950,547, filed on Mar. 10, 2014.

(51) Int. Cl. G06Q 30/02; H04W 4/021; H04W 4/23

(52) U.S. Cl. CPC G06Q 30/0234; G06Q 30/0235; G06Q 30/0267; H04W 4/23; G06Q 30/0261; H04W 4/021; G06Q 30/0271

(57) ABSTRACT

A system that includes at least one handheld device having a software application installed thereon. The software application programmed to: (i) fetch identifiers for wireless network zones in which the at least one handheld device is within; (ii) compare the identifiers for wireless network zones in which the at least one handheld device is within to stored identifiers for wireless network zones associated with the software application; and (iii) if a match is found, perform an instruction.

### CROSS REFERENCE TO RELATED APPLICATIONS

This application is a continuation in part of U.S. patent application Ser. No. 14/643,739 and claims priority to U.S. Provisional Pat. App. Ser. No. 61/950,547 filed on Mar. 10, 2014 and U.S. Provisional Pat. App. Ser. No. 62/024,746 filed on Jul. 15, 2014, all of which arc incorporated by reference in their entirety.

### BACKGROUND

The subject matter described herein relates to system and method for providing retail discounts.

Retailers offer consumers discounts on products and services in many forms, e.g., paper coupons, electronic coupons, loyalty cards, etc. In many instances, a customer must previously have knowledge about discounts in order to use these discounts or a consumer must be enrolled in the loyalty program to receive automatic discounts. Also, often consumers forget paper coupons at home and lose out on the discount advertised.

With the advent of smartphones, retailers are considering different methods of informing consumers about discounts and products using the smartphone as an advertising tool. The retailers are cautious as not to over advertise in this fashion as consumers may simple shutoff a service that is not useful or overused by a retailer who sends too many advertisements.

Customers can also use their smartphones and search the internet for active coupons while they are in a retail store. These coupons are then displayed on their smartphone and presented at the register during their purchase. This type of activity can give the retail store some insight into user purchases but advertising and marketing opportunities are lost. Also, most consumers do not have the time or patience to search for these coupons.

### SUMMARY

The disclosed technology relates to a system and method for providing retail discounts. That is, the disclosed technology offers a consumer a retail discount in real-time or near-real time. The offer can be attached to a condition, a set of conditions or a performance of an action. Once the condition is satisfied or the performance is complete, die discount can he electronically displayed on the customer's handheld device. The condition or action can be, e.g., scanning an item, watching a promotional video, answering a question, trying a free sample, picking a most-favored item out of an array of items or combinations thereof. These discounts and conditions can be customizable for specific retailers.

In one implementation, a system can comprise: at least one handheld device having a software application installed thereon, the software application programmed to: (i) fetch at least one identifier for wireless network zones in which the at least one handheld device is within; (ii) compare the at least one identifier for wireless network zones in which the at least one handheld device is within to stored identifiers for wireless network zones associated with the software application; and (iii) if a match is found, perform an instruction. In some implementations, the instruction can shift the software application from an inactive mode to an active mode. In some implementations, the fetch step can be performed on a regulated time interval. In some implementations, the regulated time interval can be once a minute.

In one implementation, a system useful in a retail setting allowing handheld devices to offer commercial opportunities, the system comprising: (a) at least one handheld device having a discount delivery software application installed thereon; and (b) computer server, which computer server is coupled to the at least one handheld device and programmed to: (i) receive from the at least one handheld device an activation signal indicating activation of the discount delivery software application; (ii) automatically identifying a current location of the at least one handheld device; (iii) in response to identification of the current location of the at least one handheld device, automatically retrieve an offer of a discount for a retail store associated with the current location of the handheld device; (iv) using the otter retrieved, automatically generate and transmit to the at least one handheld device an offer that displays offer terms including at least one action associated with the offer terms; (v) receive from the at least one handheld device a verification signal indicating that the at least one action associated with the offer terms has been completed; (vi) in response to the verification signal, automatically retrieve a discount for the retail store; and (vii) using the discount retrieved, automatically generate and transmit to the at least one handheld device the discount that displays discount terms.

In some implementations, the discount delivery software application includes location services. In some implementations, the discount delivery software application is automatically activated upon entering the retail store. In some implementations, the discount delivery software application is manually activated upon entering the retail store.

In some implementations, the system further comprises: a database which includes at least one offer and at least one discount for the retail store associated with the current location of the handheld device.

In some implementations, the offer terms further include at least one of potential: store coupons, manufacturer coupons, price reductions on whole purchase orders, price reductions from certain manufacturers, price reductions on a most expensive item in purchase order, price reductions on packages of two or more items, introductory rates for new items, any other pricing methodology and combinations thereof. In some implementations, the at least one action associated with the offer terms is at least one of scanning a retail item, watching a promotional video, answering at least one question, trying a free sample, picking a most-favored item out of an array of items and combinations thereof. In some implementations, a verification signal is generated after completion of the at least one action associated with the otter terms. In some implementations, the discount terms include at least one of store coupons, manufacturer coupons, price reductions on whole purchase orders, price reductions from certain manufacturers, price reductions on a most expensive item in purchase order, price reductions on packages of two or more items, introductory rates for new items, any other pricing methodology and combinations thereof In some implementations, the discount terms include an expiration date and time.

In another implementation, a system useful in a retail setting serving handheld devices offering commercial opportunities, the system comprises: (a) a computer server; and (b) at least one handheld device having a discount delivery software application installed thereon, which the at least one handheld device is coupled to the computer server and programmed to: (i) transmit to the computer server an activation signal indicating activation of the discount delivery software application and a current location of the at least one handheld device; (ii) in response, automatically receive an offer of a discount for a retail store associated with the current location of the handheld device; (in) using the offer received, automatically display offer terms including at least one action associated with the offer terms: (iv) transmit from the at least one handheld device a verification signal indicating that the at least one action associated with the offer terms has been completed; (v) in response, automatically receive a discount for the retail store; and (vi) using the discount received, automatically display discount terms. In some implementations, the discount delivery software application includes location services. In some implementations, the discount terms include an expiration date and time.

In another implementation, a system useful in a retail setting allowing handheld devices to offer commercial opportunities, the system comprising (a) a computer server; and (b) at least one handheld device having a discount delivery software application installed thereon, which the at least one handheld device is coupled to the computer server, the at least one handheld device programmed to: (i) receive a transmission from a wireless network; (ii) compare the wireless network to a list of wireless networks associated with participating stores and stored on the at least one handheld device; (iii) if the wireless network matches a wireless network from the list of wireless networks associated with participating stores, activate the discount delivery software application; (iv) transmit to the computer server (A) an activation signal indicating an on-state of the discount delivery software application and (B) a network profile of the wireless network that matched the wireless network from list of wireless networks associated with participating stores; (v) in response, automatically receive a discount for a retail store associated with the network profile of the wireless network that matched the wireless network from list of wireless networks associated with participating stores; and (vi) using the discount received, automatically display discount terms.

In another implementation, a method comprising the steps of: receiving an offer of a discount for a retail store associated with a current location of a handheld device, the offer being associated with at least one action, the offer being displayed on the handheld device; providing an input signifying that the at least one action is complete to a server; and receiving the discount on the handheld device from the server.

In some implementations, the at least one action is at least one of scanning a retail item, watching a promotional video, answering at least one question, trying a free sample, picking a most-favored item out of an array of items and combinations thereof.

In some implementations, the method further comprises the steps of: offering a gaming option; receiving an input signifying a product in response to the gaming option; matching the product to products contained in a demographic database; and accruing points for matches. In some implementations, the retail discount is displayed on a handheld device.

In some implementations, the method further comprises the steps of: establishing geo-location coordinates for a handheld device; and transmitting the geo-location coordinates to a server. In some implementations, the method further comprises the steps of poll n fur known wireless networks; and establishing the current location when a known wireless network is found in some implementations, the method further comprises the steps of activating a software application when the known wireless network is found. In some implementations, the method further comprises the steps of: transmitting the specific wireless network to a server; and receiving an offer that is matched with the specific wireless network.

In some implementations, the offer is associated with at least one action. In some implementations, the method further comprises the steps of: receiving at least one input signifying that the least one action is complete; and transmitting the at least one input to the server. In some implementations, the method further comprises the steps of: receiving a discount in association with the offer, the discount being displayed on the mobile device. In some implementations, the, at least one action is scanning a barcode associated with an item. In some implementations, the at least one action is watching a streaming video. In some implementations, the at least one action is trying a sample of a product.

In another implementation, a system comprising: one or more processors; one or more computer-readable storage mediums containing instructions configured to cause the one or more processors to perform operations including: receiving an offer of a discount for a retail store associated with a current location of a handheld device, the offer being associated with at least one action, the offer being displayed on the handheld device; providing an input signifying that the at least one action is complete to a server; and receiving the discount on the handheld device from the server.

In another implementation, a method comprising the steps of: receiving an offer of a discount for a retail store associated with a current location of a handheld device, the offer being associated with at least one action, the offer being displayed on the handheld device; providing an input signifying that the at least one action is complete to a server; and receiving the discount on the handheld device from the server.

In some implementations, the at least one action is at least one of scanning a retail item, watching a promotional video, answering at least one question, trying a free sample, picking a most-favored item out of an array of items and combinations thereof. In some implementations, the retail discount is displayed on a handheld device.

In some implementations, the method further comprises the steps of: establishing geo-location coordinates for a handheld device; and transmitting the geo-location coordinates to a server.

In some implementations, the method further comprises the steps of: polling for known wireless networks; and establishing the current location when a known wireless network is found.

In some implementations, the method further comprises the steps of: activating a software application when the known wireless network is found.

In another implementation, a method comprising the steps of: receiving an offer of a discount for a participating retailer based on a condition, the offer being proffered when a real-time location of a handheld device is matched with, a location of the participating retailer; satisfying the condition; and receiving the discount on the handheld device.

In some implementations, the method farther comprises the steps of: polling for known wireless networks; and establishing the current location when a known wireless network is found.

In some implementations, the method further comprises the steps of: activating a software application when the known wireless network is found.

In another implementation, a method comprising the steps of receiving a potential discount at a participating retailer on a handheld mobile device, the potential discount being attached to a condition, the potential discount being proffered when a real-time location of the handheld device is associated with a geographic location of the participating retailer: receiving an input signifying the condition has been satisfied; and receiving a discount on the handheld device, the discount matching the potential discount.

In some implementations, the method further comprises the steps of: determining a current location of a mobile computing device: and determining a store associated with the current location.

In another implementation, a method comprising the steps of: receiving geo-location coordinates for a handheld device: determining a geo-location based on the geo-location coordinates; determining a retail store associated with the geo-location; retrieving an offer of a retail discount and at least one action from a database; providing the offer of the retail discount and the at least one action to the handheld device; receiving an input signifying that the at least one action is complete: and providing a retail discount to the handheld device.

In another implementation, a method comprising the steps of: determining a current location of a mobile computing device; determining a store associated with the current location; retrieving data associated with the store associated with the current location from a database, the data including an offer for a discount at the store and at least one action; performing the at least one action; and receiving the discount at the store.

In another implementation, a method comprising the step of: activating a software application stored on a mobile device when a specific wireless network is recognized by the mobile device.

In another implementation, a method comprising the step of: transmitting the specific wireless network to a server; and receiving an offer that is matched with the specific wireless network. In some implementations, the offer is associated with at least one action. In some implementations, the method further comprises the steps of receiving at least one input signifying that the least one action is complete; and transmitting the at least one input to the server.

In some implementations, the method further comprises the steps of receiving a discount in association with the offer, the discount being, displayed on the mobile device. In some implementations, the at least one action is scanning a barcode associated with an item. In some implementations, the at least one action is watching a streaming video. In some implementations, the at least one action is trying a sample of a product.

The advantage of the disclosed technology is that it solves a discount delivery method that came into existence with the advent of smartphones. Before smartphones, retailers and manufactures advertised using newspaper ads and home delivery to inform consumers about special pricings within a store or product. The interact, specifically, web pages and e-mail provided these retailers and manufacturers another method for sending special pricing to consumers. With the advent of the smartphone, these same retailers have been trying different method to inform these users about this special pricing information through the smartphone, e.g., allowing a user to open an app on their smartphone and search for the retailer or manufacturer directly, or, sending special pricing information to a customer's smartphone when the customer walks passed a Bluetooth-ready display case. The problem with these delivery methods is that the consumer may or may not have time to perform a search for specific discounts or they may or may not be interested in items sent to their phone. It is also very easy for the consumer to deactivate these features on their smartphone, e.g., if they believe they are being inundated with pricing offers or the offers are not directed towards products they want.

Another problem with these methods is that they miss a great opportunity for a consumer to view new products or other products that may be of interest to them. To overcome these shortcomings, the disclosed technology is an easy to use and intuitive delivery system that not only seamlessly provides discounts to existing customers but provides an incentive for that consumer to view other products or get involved with new product development.

Another advantage of the disclosed technology is that a retailer can capitalize on a consumer's visit to a brick and mortar store. That is, a consumer who walks into a store will be given discounts ID exchange for actions that the retailers would like the consumer to perform. These actions can promote the advertising and sale of items the consumer was not informed about.

### BRIEF DESCRIPTION OF THE DRAWINGS

FIG. 1 shows a flow chart illustrating an example of the disclosed technology;

FIG. 2 shows a flow chart illustrating an example of the disclosed technology;

FIG. 3 shows a flow chart illustrating an example of the disclosed technology;

FIG. 4 shows a schematic diagram of an example of the disclosed technology; and

FIG. 5 shows a flow chart illustrating an example of the disclosed technology.

### DETAILED DESCRIPTION

The system and method for providing retail discounts who are, e.g., currently in a brick and mortar store. That is, the system and method can be capable of determining a location of a mobile computing device, associating the location with a retail store and offering discounts to a consumer based on satisfying a condition or performance of an action while in the store. The discounts can be applied for in-store purchases for immediate use or near-immediate use.

The mobile computing device can be a laptop, a smartphone, a tablet or any other mobile computing device capable of connecting to a mobile or wireless network.

It should be noted that system and method can be implemented on a computing device separate from handheld devices, or the functionality of system and method can be implemented completely, or partially, on handheld devices, as desired. For purposes of the present discussion, the functionality of method and system will be described as a system having servers connected to handheld devices through a network. Of course, other embodiments can be used as well.

The system and method can be part of a downloadable application for a mobile device, e.g., smartphone. The term “application” as used herein refers to a computer software application, otherwise known as an “app” that is run and operated on a mobile device.

The app can allow consumers to register and participate in a virtual discount program. A consumer can register with the application by providing a name, age, e-mail address, sex, etc. The registration can also he anonymous with only the age and sex of the user for marketing purposes. Other data can be collected on the registrant, e.g., marital status, any dependents, ages of dependents, zip code of permanent address, zip code of other addresses and other general information that provides marketing insight into consumer habits. A customer number can be granted for a valid registration or the consumers can create a consumer profile with a unique consumer I.D.

The consumer data can be stored in a database associated with a server. The server can be remote from the mobile device, e.g., an on-site server or an off-site server. The mobile device can link with the server using a mobile or wireless network connection. If an on-site database is used, the server can be maintained by the retailer themselves and any data collected may not be shared with other retailers. In other implementations, the server can be maintained by an outside provider and data may be shared between retailers.

The database can also store data pertaining to discounts offered by the retailers and the actions or conditions attached to the offers.

The disclosed technology is capable of identifying the location of the mobile computing device. The location system can be any conventional locating system. A location component can include a global positioning system that periodically updates geographic position information using at least longitude and latitude that indicates the location of the handheld device in which the app is installed. The location component can be turned on/off by user or run in background.

The application can be in electronic communication with a GPS in the mobile device and can thus automatically obtain location information of the user. The application can actively receive offers for discounts as the user's location changes. For example, when entering a retail store, an alert can be activated on a mobile device and an otter for a discount associated with the retail store can he displayed on the screen of the mobile device. The alert can be an alarm, a noise, a vibration, a visual display or combinations thereof.

The term “discount” as used herein refers to any type of pricing scheme, e.g., store coupons, manufacturer coupons, price reductions on whole purchase orders, price reductions from certain manufacturers, price reductions on a most expensive item in purchase order, price reductions on packages of two or more items, introductory rates for new items, and any other pricing methodology.

In some implementations, the location can be obtained by entering a wireless network zone operated by the retail store. Upon entering the wireless network zone, the wireless network can ask if you would like to join their server and offer a discount with conditions.

In some implementations, the disclosed application can continuously poll for wireless networks associated with participating stores and when a known network is encountered, the application can notify the mobile device a known wireless connection was found. Additionally, in some implementations, once a known wireless network is identified, the application can be fully activated regardless if the user enables the wireless network connection on the mobile device. Once the application is turned on, the user can receive a notification about today's offers and conditions or actions. The application can return to standby mode once the mobile device leaves the wireless network zone. This implementation can conserve battery power and connect a consumer to the application when necessary.

In some implementations, after the application is installed on a handheld device, the disclosed application can be programmed to allow some components of the application to run in the background, e.g., when the application is, e.g., in an inactive state or in a suspend mode. In this implementation, the application can use a background fetch feature or a background application refresh feature to fetch content while the application is in, e.g., the inactive state or the suspend mode. For background, this background fetch feature can fetch information from the handheld device or from an outside service on a timeframe regulated by the application or the operating system, e.g., once a minute, once every five, minutes, once every hour, once a day. This background fetch feature takes up very little battery and CPU, and is mainly used by news/weather/social media/mail apps to update a feed so that when an application is open, the application is update to date and a user does not need to refresh the application to gel the latest news and weather.

The disclosed technology can use the background fetch feature to fetch data obtained by a wireless antenna associated with the handheld device. This is, the background fetch feature can, at pre-determined time intervals, obtain data relating to an identification of wireless networks in which the wireless antenna comes into communication, regardless if the handheld device connects with the network or not. (For example, most handheld devices have a polling feature which allows the handheld device to continuously poll for wireless networks to join.) As the handheld device comes into wireless contact with these networks, the handheld device can obtain identifying information about the wireless networks. The disclosed technology can fetch this identifying information on a regulated time interval or when the handheld device updates or populates the wireless network polling settings. Once the identifying information is received by the disclosed application, the disclosed application can match the fetched identifying information with stored identifying information relating to wireless networks associated with the application, as described above. For example, if the application receives a fetched identifier called BigBoxStore, this fetched identifier can be compared to the stored identifiers. If the disclosed application has a stored wireless network named BigBoxStore, a match will be found. If a match between the fetched networks and the stored networks occurs, an instruction can be triggered.

In one implementation, the instruction can allow the application to go from an inactive state, e.g., suspend mode, to active mode, e.g., turning on a GPS locator, allowing the application to communicate with a remote server, etc. Or once active, the application can run as intended. In other words, an application that is in an inactive mode can be switched to active mode once a match is found. The disclosed application can be used for retail purposes, but this feature can be used in any type of software application that can benefit from switching from an inactive mode to an active mode when in a particular wireless network zone.

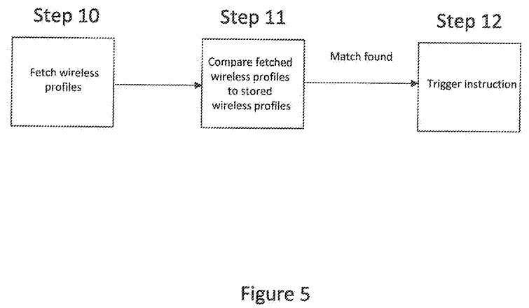

As shown in FIG. 5, the application can fetch one or more identifiers for wireless network zones in which the at least one handheld device is within (Step 10). The application can compare the fetched identifiers for wireless network zones in which the at least one handheld device is within to one or more stored identifiers for wireless network zones associated with the software application (Step 11). If a match is found, an instruction can be triggered (Step 12).

In some implementations, the stored identifiers can be uploaded and stored as a list of network profiles for wireless networks associated with participating stores. In other implementation, the background fetch feature can he linked to an existing feature on the handheld device that automatically links the mobile device to known networks. The stored identifiers can be stored in a separate file or stored in an existing file containing known wireless networks profiles. The stored identifiers can include IP addresses, subnet masks numbers, router numbers, DNS numbers, domains or client IDs. The folder for the stored identifiers can also include instructions to turn on a particular application or application feature when a match occurs regardless if the user connects to the matched wireless network. The stored identifiers can be updated on a regular basis, e.g., each time the application is turned on, when the application is updated, or on a tinted interval.

In some implementations, the location can be manually input by consumer, e.g., enter zip code. If a general location is input, a list of participating local stores may appear.

Once a location for the device is established, the location can be sent to a server or the computing can be done on the device itself. The location can be associated with a geographic location of a brick and mortar retail store. If an association between the location and a store is established, the device can request if any offers of a discount are available. If available, the details of the offer and the attached conditions are provided to the mobile device. It can be sent by text, a push notification or a stand-alone alarm component. These offers and conditions can be customized by registered retailers, product manufacturers or both. The offers can be stored in a database or databases for each store location or affiliated stores within a region.

Notifications can be sent to the mobile computing device. The notifications can include the offer. The offers can be for discounts that can be used within a limited time from the notification, e.g., immediately or within minutes to several hours after an offer is made and an action is completed.

The offer is associated with one or more actions. These discounts and conditions are customizable by the retailer and can include any action or condition taken by a consumer at the request of the retailer and, in return, receive an immediate discount on an upcoming purchase. These actions or conditions can include, e.g., scanning an item, watching a promotional video, answering a question or questions, trying a free sample, picking a most-favored item out of an array of items, combinations thereof or any other action requested by the retailer.

If the condition is attached to scanning an item or items, for convenience of the user, a coupon corral can be set up near the registers for the retail store. Within the corral can be multiple items and the consumer can be asked to scan one or more items within the corral. The items can be selected based on a demographic of the user using the consumer profile. Once and item is scanned, the application can send an input to the server that the action is completed. In some implementations, the application can ask the user if they would consider buying the product. In some implementations, the application can offer the scanned item for a reduced purchase price if bought with their current sale. For example, the price can be reduced by 50% and an additional coupon can be supplied to the user for the purchase of the scanned item.

In some implementations, kiosk can be set up and located throughout store. These kiosks can display the item to be scanned or show depictions and descriptions of the items to be scanned. The kiosk can also be prominently displayed at or near check-out lines.

If the condition is attached to watching a promotional video, the video can be streamed to the mobile device and an input can be sent to the server when the video is completed. In some implementations, the video can be displayed at a kiosk and an image can be displayed and scanned by the consumer to prove the consumer watched the video.

If the condition is attached to answering a question or questions, the questions can be displayed on the mobile device and can consist of multiple-choice questions that are sent to the server. Once completed, the answers can be sent to the server as an input that the task was completed.

If the condition is attached to trying a free sample, the application can have a video or camera feature to record the trying of the sample. This picture or video can be uploaded to the server. A scanable code can also be used for task completion verification or a query of rating the sample from 1-10 can be used for verification, or both.

If the condition is attached to picking a most-favored item out of an array of items, e.g., what color shirt do you prefer. Two or more shirts can be displayed and the consumer can scan the shirt they like more.

Once the condition is satisfied, the discount can be displayed on the mobile device as a scanable barcode or some other code or image that can translated to the cashier or self-service register. That is, the handheld device can be configured to render barcodes associated with coupons that can be scanned by barcode readers at retailer point of sale locations. A barcode generator can generate a scannable barcode and present it on display of the mobile device so that it can be scanned by electronic barcode reader at a retail establishment. The barcode can be customized and be associated with the customer number. In some implementations, after a purchase is made, the details of the sale can be transmitted to the server along with a customer number for marketing purposes.

For example, Consumer A has installed the software program on her mobile computing device and has registered with the server associated with the software program. Consumer A chose an option to have the software program notify her when she is in a location that is currently offering a discount.

Consumer A is out shopping and Consumer A enters Store X. Upon entering the store, Consumer A receives notification of an offer for a discount at Store X, e.g., “Dear Consumer A, We are offering a 10% discount at checkout for all items you purchase today. Please scan the barcode on Item M, Item N and Item O in the coupon corral located next to register 10 to receive your discount.”

As Consumer A shops at the store, Consumer A locates Items M, N and O and scans them. The application can query the user and ask “Is this item of interest to you? Yes/No.” If a No is received, Consumer A is sent a discount for the in-store purchases for the day. If a Yes is received, a follow-up query can be presented “Would you like to purchase this item for 50% off the retail price? Yes/No.” If No, Consumer A is sent a discount for the in-store purchases for the day. If Yes, Consumer A is sent a discount for the in-store purchases for the day along with a second 50% discount for the item they responded favorably to, Consumer A presents the discount or discounts to the checkout employee.

In some implementations, Consumer A can receive a notification of an offer for a chance to win free merchandise at Store X, e.g., “Dear Consumer A, If you scan the barcode on Item P, you will have a 1 in 10 chance to win the Item P for free today with your purchases.” Those who do not win may be given a chance to buy the item at a discounted price for playing.

In another implementation, a game aspect can be incorporated into the application. The gaming aspect can offer tree merchandise for consumers who play the game and score a high amount of points within the game. In order to score points, the application can ask the consumer to name three products that are of high interest to the consumer, if any of these products matches products within a product demographic database associated with the application and the demographic of the consumer, the consumer can accrue points for each match. In another implementation, the application can ask the consumer to scan a product that the consumer believes to he in their demographic, if the scanned product matches products within a product demographic database, the consumer can gain points. At certain point levels, the consumer can redeem the points for retail products or the points can he redeemed for greater discount coupons at particular stores.

Another gaming aspect can be to ask the consumer the price of item. If the consumer comes within a certain price range, the consumer can receive better discounts. If the consumer guesses the exact price, the item can be given to the consumer for free.

Another gaming aspect can be that if a consumer completes a scavenger hunt within a specific time frame, the consumer can receive additional discounts. The scavenger hunt can be any number of items located throughout the store.

In some implementations, if a consumer already possesses a discount coupon in which they were going to apply to their purchase and they receive a notification. The application can request the consumer to scan the barcode of the coupon and the consumer can receive an offer for a steeper discount if they perform the actions along with presenting the paper coupon at check-out

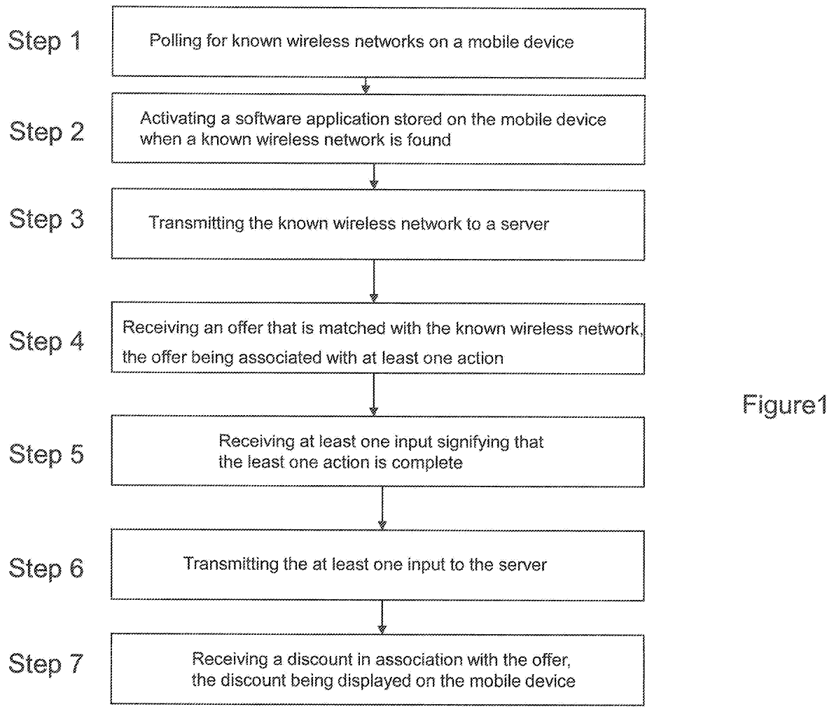

FIG. 1 is a flow chart showing an example of the disclosed technology. A mobile device can poll for known wireless networks (Step 1). Once a known wireless network is found, a software application, e.g., a discount app, is activated on the mobile device (Step 2). The name of the known network is transmitted to a server (Step 3). In return, the mobile device receives an offer that was matched with the known wireless network, stored on the server (Step 4). The offer can he associated with one or actions or conditions. The mobile device receives one or more inputs signifying that the action(s) is(are) complete (Step 5). The mobile device transmits the input(s) to the server (Step 6). In return, the mobile device receives a discount in association with the offer and the discount can be displayed on the mobile device (Step 7).

In another implementation, the condition to be satisfied can be that the offerer of the discount can ask that the user of the mobile device to visit a website operated by the offerer. The website will be shown on the mobile device. The user can receive the discount by visiting the website and accepting an offer displayed on the website, e.g., an offer to buy an item now, or the user may get a lesser discount, if after visiting the website, the user rejects the offer. In some implementations, the website can display multiple offers to the user for discounts on multiple items with discounts being applied to each item separately or bundles into one offer. The user can receive large discounts by accepting all the offers or offer bundles, and lesser discounts for accepting less than all of the offers, and a still lesser discount on other items, for accepting none of the offers. In some implementations, the received discount may not display each offer and whether it was accepted or declined but the received discount can simply be a statement of the number of offers that have been made and accepted. This can be done for each offer or could be part of the user's buying history.

In some implementations, the user can be asked if they recognize the identity of the offerer of the discount and the user can receive additional discounts depending on whether the determination is correct or partially correct. Greater discounts can also be given on the number of items that have been viewed and which items have been purchased.

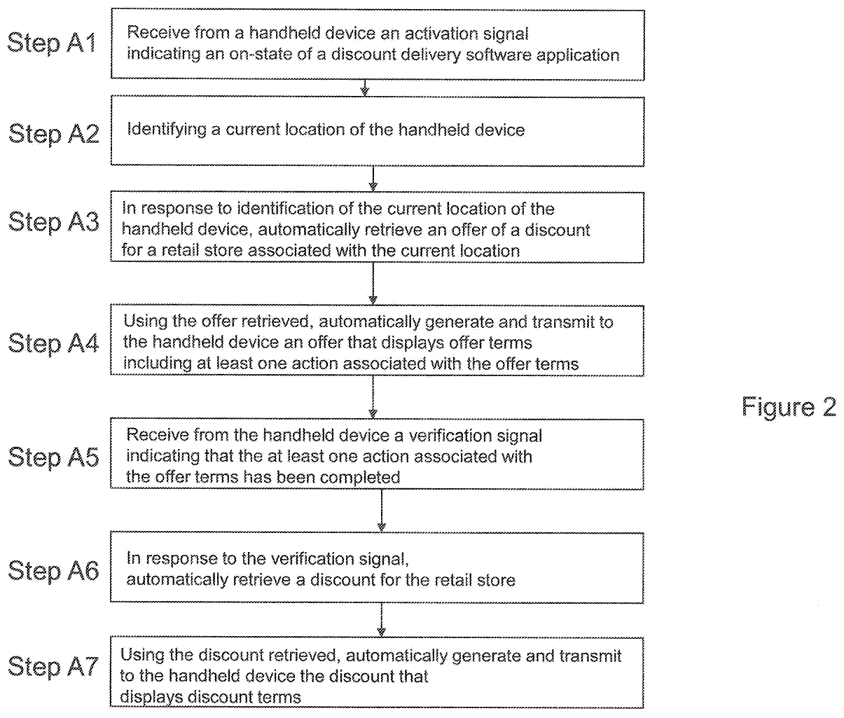

FIG. 2 is a flow chart showing, another example of the disclosed technology. In this implementation a system can be used in a retail setting to allow handheld devices to offer commercial opportunities to consumers who enter a particular retail store. The system can include any handheld device that has a discount delivery software application, as described above, installed thereon and a computer server communicatively coupled to the handheld devices. The computer server can be programmed to offer commercial opportunities to consumers who enter a particular retail store. In one implementation, the computer server can receive from a handheld device an activation signal indicating activation of the discount delivery software application, (Step A1). In some implementations, the activation signal can be generated when (1) the handheld device enters into a wireless network zone associated with the computer server while the app is in an on-state, (2) the handheld device enters into a wireless network zone associated with the computer server while the app goes from an off-state to an on-state or (3) a user requests generation. In other implementations, the discount delivery software application can be automatically activated upon entering the retail store or manually activated by the consumer upon entering the retail store.

Once an activation signal is received by the computer server, the computer server can automatically identify a current location of the at least one handheld device using techniques as described above. (Step A2). In response to identification of the current location of the handheld device, the computer server can automatically retrieve an offer of a discount for the retail store that is associated with the current location of the handheld device. (Step A3). These offers can be stored in a database, the database can include offers and discounts for the retail store associated with the current location of the handheld device.

Using the offer retrieved, the computer server can automatically generate and transmit to the handheld device an offer that displays offer terms including at least one action associated with the offer terms. (Step A4). The offer terms can include store coupons, manufacturer coupons, price reductions on whole purchase orders, price reductions from certain manufacturers, price reductions on a most expensive item in purchase order, price reductions on packages of two or more items, introductory rates for new items, any other pricing methodology and combinations thereof. And the at least one action associated with the offer terms can include scanning a retail item, watching a promotional video, answering one or more questions, trying a free sample, picking a most-favored item out of an array of items and combinations thereof.

After a user views and completes the action, the computer server can receive from the handheld device a verification signal indicating that the at least one action associated with the offer terms has been completed. (Step A5). In response to the verification signal, the computer server can automatically retrieve a discount for the retail store. (Step A6). Using the discount retrieved, the computer server can automatically generate and transmit to the handheld device the discount that is capable of displaying the discount terms on the handheld device. (Step A7). The discount terms can include store coupons, manufacturer coupons, price reductions on whole purchase orders, price reductions from certain manufacturers, price reductions on a most expensive item in purchase order, price reductions on packages of two or more items, introductory rates for new items, any other pricing methodology and combinations thereof. The discount terms can also include an expiration date and time.

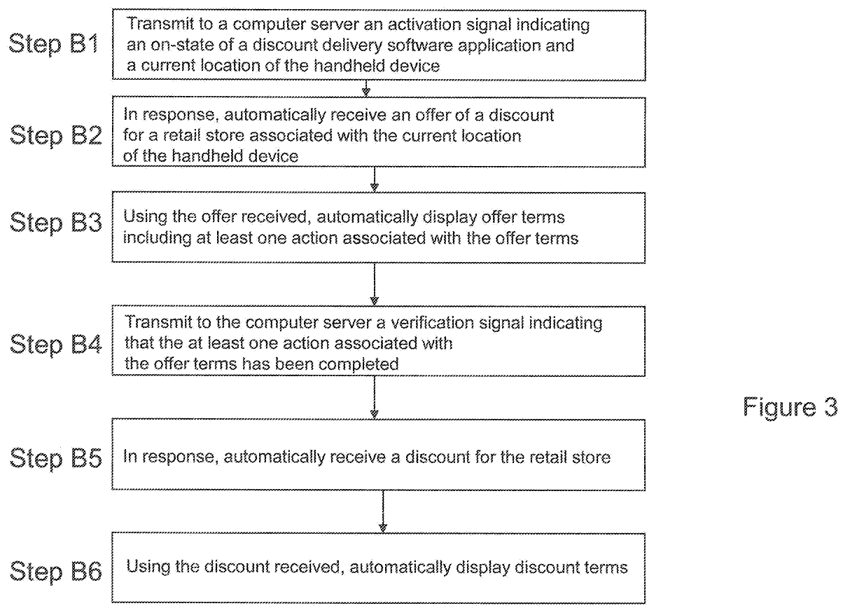

FIG. 3 is a flow chart showing another example of the disclosed technology. In this implementation, tire system can be used in a retail setting serving handheld devices offering commercial opportunities to consumers. The system can include a computer server; and handheld devices having a discount delivery software application installed thereon. The handheld devices can be communicatively coupled to the computer server. The discount delivery software application is programmed to transmit to the computer server an activation signal indicating an on-state of the discount delivery software application on a particular handheld device and a current location of the handheld device. (Step B1). In some implementations, the software application can include location services. In some implementations, the software application can be automatically activated upon entering the retail store or manually activated upon entering the retail store by a consumer.

In response, the software application can automatically receive an offer of a discount for a retail store associated with the current location of the handheld device. (Step B2). Using the offer received, the software application automatically displays the offer terms including at least one action associated with the offer terms on the handheld device. (Step B3). Using the handheld device, the software application, transmits to the computer server a verification signal indicating that the at least one action associated with the offer terms has been completed. (Step B4). In response, the software application, automatically receives a discount for the retail store. (Step B5). Using the discount received, the software program automatically display discount terms on a display of the handheld device. (Step B6). The display can be shown at a sales register for an immediate discount.

In another implementation, a system can he use in a retail setting allowing handheld devices to offer commercial opportunities. The system can include a computer server and (b) one or more ne handheld device having a discount delivery software application installed thereon, which the at least one handheld device is coupled to the computer server, the at least one handheld device programmed to: (i) receive a transmission from a wireless network; (ii) compare the wireless network to a list of wireless networks associated with participating stores and stored on the at least one handheld device; (iii) if the wireless network matches a wireless network from the list of wireless networks associated with participating stores, activate the discount delivery software application; (iv) transmit to the computer server (A) an activation signal indicating an on-state of the discount delivery software application and (B) a network profile of the wireless network that matched the wireless network from list of wireless networks associated with participating stores; (v) in response, automatically receive a discount for a retail store associated with the network profile of the wireless network that matched the wireless network from list of wireless networks associated with participating stores; and (vi) using the discount received, automatically display discount terms.

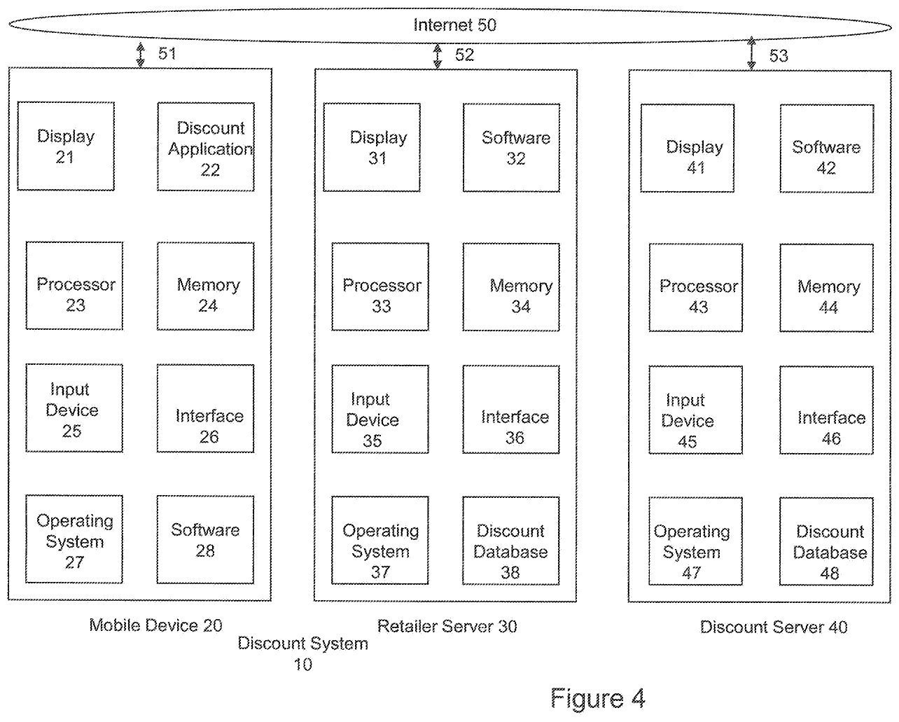

FIG. 4 is a schematic diagram of an example of a discount system 10. The discount system includes a mobile device 20, a retail server 21 and discount server 22. For ease of explanation only one of each device is shown but more than one of each is contemplated.

The mobile device 20 includes a display 21, a discount application 22, a processor 23, a memory 24, an input device 25, an interface 26, an operating system 27 and software 28.

The retail server 30 includes a display 31, application software 32, a processor 33, a memory 34, an input device 35, an interface 36, an operating system 37 and discount database 38.

The discount server 40 includes a display 41, software 42, a processor 43, a memory 44, an input device 45, an interface 46, an operating system 47 and discount database 48.

The mobile devices 20 and servers 30, 40 can be connected to one another over an internet connection 50 but more secure connections are contemplated.

In some implementations, the system of FIG. 4 can be split into a mobile device-server environment communicatively connected over the internet 50 with connectors 51, 52, 53 where the one or more servers 20, 30, 40 include hardware as shown in FIG. 4 and also code for providing discounts, code for polling networks, matching polled networks with known networks and code for matching a known network with associated discounts and conditions.

The operating systems 27, 37, 47 can be multi-user, multiprocessing, multitasking, multithreading, real-time and the like. The operating systems 27, 37, 47 may perform basic tasks, including but not limited to: recognizing input from input devices 25, 35, 45; sending output to display devices 21, 31, 41; keeping track of files and directories on computer-readable mediums 24, 34, 44 (e.g., memory or a storage device); controlling peripheral devices (e.g, disk drives, printers, etc.); and managing traffic on the one or more buses 51, 52, 53.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus to execution by a data processing apparatus. The computer storage medium can be, or be included in, a computer readable storage device, a computer readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Embodiments of the subject matter described in this specification can be implemented in a computing system that includes a back-end component, e.g., as a data server, or that includes a middleware component, e.g an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can, include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The foregoing Detailed Description is to be understood as being in every respect illustrative and exemplary, but not restrictive, and the scope of the disclosed technology disclosed herein is not to be determined from the Detailed Description, but rather from the claims as interpreted according to the full breadth permitted by the patent laws. This to be understood that the embodiments shown and described herein are only illustrative of the principles of the disclosed technology and that various modifications may be implemented by those skilled in the art without departing from the scope and spirit of the disclosed technology. Those skilled in the art could implement various other feature combinations without departing from the scope and spirit of the disclosed technology. Although the embodiments of the present disclosure have been described with specific examples, it is to be understood that the disclosure is not limited to those specific examples and that various other changes, combinations and modifications will be apparent to one of ordinary skill in the art without departing from the scope and spirit of the disclosed technology which is to be determined with reference to the following claims.

1. A system comprising:
at least one handheld device having a software application installed thereon, the software application programmed to:
(i) fetch at least one identifier for wireless network zones in which the at least one handheld device is within;
(ii) compare the at least one identifier for wireless network zones in which the at least one handheld device is within to stored identifiers for wireless network zones associated will the software application; and
(iii) if a match is found, perform an instruction.

2. The system of claim 1 wherein the instruction shifts the software application from an inactive mode to an active mode.

3. The system of claim 1 wherein the fetch step is performed on a regulated time interval.

4. The system of claim 3 wherein the regulated time interval is once a minute.
